(19) United States
(12) Patent Application Publication
(10) Pub. No.: US 2020/0216608 A1
(43) Pub. Date: Jul. 9, 2020

(54) PROCESS FOR PRODUCING A LACTONE COPOLYMER

(71) Applicant: INGEVITY UK LTD, Cheshire (GB)

(72) Inventors: Snjezana TRUPINA GRONLUND, Kristianstad (SE); Christoffer PAULSSON, Eslov (SE); Anthony MAHER, Cheshire (GB)

(21) Appl. No.: 16/648,817

(22) PCT Filed: Sep. 18, 2018
(86) PCT No.: PCT/SE2018/050953

§ 371 Date: Mar. 19, 2020

(30) Foreign Application Priority Data
Sep. 22, 2017 (SE) 1730259-7

(51) Int. Cl. C08G 63/08; C08G 63/82

(52) U.S. Cl. CPC C08G 63/08; C08G 63/823

(57) ABSTRACT

Disclosed is a process for production of a lactone copolymer by copolymerization of a reaction mixture comprising at least one lactone monomer, at least one second monomer and at least one catalyst and optionally at least one initiator/activator and/or at least one antioxidant, wherein said reaction mixture is pre-treated with an effective amount of at least one acid scavenger and wherein said copolymerization is performed in presence of an effective amount of said at least one acid scavenger.

The present invention refers to a process wherein a lactone copolymer is obtained by copolymerization of a reaction mixture comprising at least one lactone monomer, at least one second monomer and at least one catalyst and optionally at least one initiator/activator and/or at least one antioxidant wherein the reaction mixture is pre-treated with an effective amount of at least one acid scavenger and wherein the copolymerization is performed in presence of an effective amount of said at least one acid scavenger.

Biodegradable copolymers yielded from for instance lactones, lactides and glycolides are widely used in for instance biomedical applications, such as tissue engineering and drug delivery systems, adhesives and bioplastics. Production processes are well known in the art and include for instance ring opening random or block copolymerization in presence of one or more catalysts, such as catalysts comprising organometallic compounds and complexes.

There is a certain need and desire to limit the amount of catalyst used as it will render the final product more environmentally friendly and acceptable. A further problem is that monomers, based on for instance lactic and/or glycolic acids, such as lactides and glycolides, form free acids in the presence of moisture. This causes problems in shipping and storage and not least in (co)polymerization processes. A typical effect noticed in (co)polymerization processes is that the reaction time significantly increases and that larger amounts of catalysts and thus catalyst deactivators will be required. It has now quit unexpectedly been found that treatment with and presence of an acid scavenger in copolymerization of at least one lactone and at least one second monomer will result in a process exhibiting reduced amount of catalyst and/or shorter reaction time as the catalyst will not be consumed by acidic catalyst deactivators present in used raw materials and or produced in situ during the copolymerization. Less amount of catalysts means less amount of catalyst deactivators added to stop the copolymerization. It has furthermore unexpectedly been found that said treatment and presence result in a shorter reaction/processing time.

Said at least one acid scavenger is in preferred embodiments of the present invention selected from for instance at least one monomeric, oligomeric or polymeric carbodiimide, such as an aromatic carbodiimide, which suitably can be exemplified by bis-(2,6-diisopropylphenyl)carbodiimide and poly-bis-(2,6-diisopropylphenyl)carbodiimide, and/or at least one arylene oxazoline, such as 1,3-phenylene bis-oxazoline. Said acid scavenger is, however, not limited to these exemplified compounds. The acid scavenger is suitably added to said reaction mixture in an effective amount corresponding to for instance the acid value of obtained reaction mixture and to in situ formed acidic catalyst deactivators.

Said at least one lactone monomer is in embodiments of the present invention α-acetolactone, β-propiolactone, γ-butyrolactone, δ-valerolactone and/or most preferably ε-caprolactone. Said at least one second monomer is in said embodiments suitably selected from the group consisting of hydroxyalkyl (meth)acrylates, glycolides, glycolates, lactides, lactates, alkylene glycols or oxides, alkylene carbonates and/or hydrofurans. Said second monomer can be exemplified by, but not limited to, D- or L-lactides, polyethylene glycol or oxide, mono, oligo or polyalkylene glycols and oxides, mono, oligo or polyalkylene carbonates, such as triethylene carbonate, and/or tetrahydrofuran.

The process of the present invention is suitably and preferably performed at a reaction temperature of 150-250° C., such as 160-200° C., and at a feed ratio said lactone monomer to said second monomer of between 90:10 and 10:90, such as 80:20, 75:25, 60:40, 50:50, 40:60, 25:75 and 20:80. Yielded copolymer is in various embodiments either a random or a block copolymer having a molecular weight (Mn) of for instance, but not limited to, between 500 and 50000, such as 2000-20000 g/mol.

The catalyst used in the process of the present invention is in preferred embodiments a catalyst comprising at least one organometallic compound or complex, such as a tin, zinc, aluminum and/or molybdenum comprising compound or complex. The most preferred catalyst is a stannous octoate, such as tin(II)ethylhexanoate. The catalyst is present in a catalytically effective amount, such as 25-250 or 75-150 ppm and charged in one or more portions.

The most preferred copolymer is obtained by copolymerizing, in embodiments of the present process, ε-caprolactone and a D- or L-lactide having a formula of

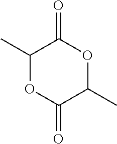

Suitable initiators/activators are found among for instance alkyl, alkylaryl and polyether alcohols, such as n-butyl alcohol, tert.butyl alcohol, lauryl alcohol, cetyl alcohol (1-hexadecanol), stearyl alcohol and/or cicosyl alcohol, and suitable antioxidants are found among for instance substituted phenols and phenylene diamines and derivatives thereof, such as N,N′-di-2-butyl-1,4-phenylenediamine, 2,6-di-tert.butyl-4-methylphenol, 2,4-dimethyl-6-tert.butylphenol, 2,4-dimethyl-6-tert.butylphenol, 2,4-dimethyl-6-tert.butylphenol and 2,6-di-tert.butyl-4-methylphenol, 2,6-di-tert.butyl-phenol, 3,9-bis(2,4-di-tert.butylphenoxy)-2,4,8,10-tetraoxa-3,9-diphosphaspiro [5.5]undecane, and/or alkylhydroquinones, such as tert.butylhydroquinone and/or alkylated, such as butylated, hydroxyanisoles and hydroxytoluenes.

In a further aspect, the present invention refers to the use of a lactone copolymer obtained by the process as herein above disclosed in thermoplastics, including bio-plastics, compositions for 3D printing, hot melt adhesives, medical implants and other in the art known application areas therein lactone copolymers are utilized.

Without further elaboration, it is believed that one skilled in the art can, using the preceding description, utilise the present invention to its fullest extent. In the following, Example 1 is a comparative example outside the scope of the present invention and Examples 2 and 3 are embodiments of the present invention. Moisture and oxygen free raw materials were used in all examples. Said examples show that the amount of catalyst, and thus catalyst deactivator, can be reduced and that pre-treatment of the reaction mixture with an acid scavenger and the presence of an acid scavenger during the copolymerization reduces the reaction/processing time. The examples furthermore show that said reductions do not negatively influence yielded product. In below performed experiments, the acid values are considered moderate. In accordance with the present invention it is estimated that even greater time savings will be achieved when higher acid values are present in the reactants. It is also possible, within the scope of the invention, to limit the amount of catalyst, and consequently also the catalyst deactivator, used in order to further improve the final product from an environmental as well as processing point of view.

### EXAMPLE 1 (COMPARATIVE)

196.7 g of ε-caprolactone monomer (Perstorp UK), 295.1 g of L-lactide monomer (Puralact® L, Corbion, UK), 12.2 g of cetyl alcohol as initiator/activator and 1.5 g of Irgafos® 126 (BASF, Germany) as antioxidant were charged to a reaction vessel, equipped with a heating device, agitator, temperature probe, vacuum equipment and nitrogen inlet, and mixed. The acid value of the reaction mixture was determined to be 0.4 mg KOH/g. The reaction mixture was now heated to 160° C. under nitrogen purge and 75 ppm of stannous octoate (DABCO® T9, Evonik, UK) was added as catalyst. The reaction mixture was subsequently heated to 180° C. and vacuum was applied to obtain reflux. After 1 hour, a further 75 ppm of said stannous octoate was added to the reaction mixture and after 2.5 hours yet and a further 75 ppm of said stannous octoate. Full vacuum (<50 mbar) and no reflux, indicating no or small amounts of raw materials left in the reaction mixture, was reached after 6 hrs. Finally 340 ppm of a catalyst deactivator (ABK AX-71, Adeka Palmarole, France) was admixed and yielded product discharged into a silicon tray.

Yielded product was analyzed to have 0.3% of caprolactone and 2.98% of lactide monomer.

### EXAMPLE 2

196.7 g of ε-caprolactone monomer (Perstorp UK), 295.1 g of L-lactide monomer (Puralact® L, Corbion, UK), 12.2 g of cetyl alcohol as initiator/activator and 1.5 g of Irgafos® 126 (BASF, Germany) as antioxidant were charged to a reaction vessel, equipped with a heating device, agitator, temperature probe, vacuum equipment and nitrogen inlet, and mixed. The acid value of the reaction mixture was determined to be 0.34 mg KOH/g and the reaction mixture was treated with 1.70 g of an acid scavenger (Stabaxol® 1, Rhein Chemie, Germany). The reaction mixture, now having an acid value <0.01 mg KOH/g, was heated to 160° C. under nitrogen and 75 ppm of stannous octoate (DABCO® T9, Evonik, UK) as catalyst was added. The reaction mixture was subsequently heated to 180° C. and vacuum was applied to obtain reflux. After 1 hour, a further 75 ppm of said stannous octoate was added to the reaction mixture. Full vacuum (<50 mbar) and no reflux, indicating no or small amounts of raw materials left in the reaction mixture, was reached after 2 hours. Finally 225 ppm of a catalyst deactivator (ABK AX-71, Adeka Palmarole, France) was admixed and yielded product discharged into a silicon tray.

Yielded product was analyzed to have 0.24% of caprolactone and 2.19% of lactide monomer.

### EXAMPLE 3

196.7 g of ε-caprolactone monomer (Perstorp UK), 295.1 g of L-lactide monomer (Puralact® L, Corbion, UK), 12.2 g of cetyl alcohol as initiator/activator and 1.5 g of Irgafos® 126 (BASF, Germany) as antioxidant were charged to a reaction vessel, equipped with a heating device, agitator, temperature probe, vacuum equipment and nitrogen inlet, and mixed. The acid value of the reaction mixture was determined to be 0.31 mg KOH/g and the reaction mixture was treated with 1.55 g of an acid scavenger (Stabaxol® 1, Rhein Chemie, Germany). The reaction mixture now having an acid value <0.01 mg KOH/g was heated to 160° C. under nitrogen and 150 ppm of stannous octoate (DABCO® T9, Evonik, UK) was added as catalyst. The reaction mixture was subsequently heated to 180° C. and vacuum was applied to obtain reflux. Full vacuum (<50 mbar) and no reflux, indicating no or small amounts of raw materials left in the reaction mixture, was reached after 105 minutes. Finally 225 ppm of a catalyst deactivator (ABK AX-71, Adeka Palmarole, France) was admixed and yielded product discharged into a silicone tray.

Yielded product was analyzed to have 0.28% of caprolactone and 1.98% of lactide monomer.

1. A process for production of a lactone ε-caprolactone copolymer by copolymerization of a reaction mixture comprising a ε-caprolactone monomer, a lactide monomer, an antioxidant and an alcohol as an intiator, said alcohol being selected from a group consisting of n-butyl alcohol, tert-butyl alcohol, lauryl alcohol, cetyl alcohol (1-hexane decanol), stearyl alcohol, eicosyl alcohol, wherein said reaction mixture is pre-treated with an effective amount of a monomeric, oligomeric, or polymeric carbodiimide as acid scavenger prior to the addition of a stannous octoate as catalyst and said copolymerization is performed in presence of an effective amount of said carbodiimide.

2. (canceled)

3. The process according to claim 1 wherein said carbodiimide is an aromatic carbodiimide, such as bis-(2,6-diisopropylphenyl)carbodiimide and/or poly-bz′5-(2,6-diisopropylpheny)carbodiimide.

4. (canceled)

5. (canceled)

6. (canceled)

7. The process according to claim 1 wherein said copolymer is yielded at a feed ratio said at least one lactone monomer to said at least one second monomer of between 90:10 and 10:90.

8. The process according to claim 1 wherein said copolymerization is performed at a reaction temperature of 150-250° C.

9. The process according to claim 1 wherein said copolymer is a random copolymer.

10. The process according to claim 1 wherein said copolymer is block copolymer.

11. The process according to claim 1 wherein said copolymer has a molecular weight (Mn) of between 500 and 50000 g/mol.

12. (canceled)

13. (canceled)

14. The process according to claim 1 wherein said catalyst is a stannous octoate, such as tin(II)ethylhexanoate.

15. Use of a ε-caprolactone copolymer obtained according to claim 1, in thermoplastics, including bio-plastics, compositions for 3D printing, hot melt adhesives and/or medical implants.
